(19) United States
(12) Patent Application Publication
(10) Pub. No.: US 2007/0107757 A1
(43) Pub. Date: May 17, 2007

(54) Free standing portable car washer

(76) Inventors: Neville Petherick, Prarie Du Rocher, IL (US); Gary Bievenue, Ruma, IL (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/274,989

(22) Filed: Nov. 16, 2005

(51) Int. Cl. B08B 3/12; B08B 3/00

(52) U.S. Cl. 134/123; 134/198; 134/172; 134/199

(57) ABSTRACT

A free standing portable car washer with sprays connected to a common source of water under pressure, has a device operated solely by the water under pressure from the common source for metering positively a predetermined amount of detergent to the sprays.

### CROSS REFERENCE TO RELATED APPLICATIONS

None

### STATEMENT REGARDING FEDERALLY SPONSORED RESEARCH OR DEVELOPMENT

Not Applicable

### BACKGROUND OF THE INVENTION

The broad idea of a vehicle washing apparatus including a framework carrying sprays of water is old. See for example Mackin U.S. Pat. No. 2,221,876, filed in 1933. Mackin requires pumps, uses an elaborate control system, and does not disclose a method of supplying a predetermined amount of detergent or caustic to a washing cycle or station.

Later patents, for example Fisher, U.S. Pat. No. 2,699,792 or Hopper, et al. reissue 23294 and Jones, et al. U.S. Pat. Nos. 4,369,801 and 4,739,779 require an outside source of air pressure, or, in the case of Fisher, alternatively, an educator. In none of these is a precisely measured amount of detergent dispensed with the aid only of water pressure from a common source, such as a municipal water supply.

### BRIEF SUMMARY OF THE INVENTION

In accordance with this invention, generally stated, a portable vehicle washer is provided which dispenses a metered amount of detergent in a washing cycle or station, solely by the use of the water pressure from a common source such as a municipal water supply or other existing source of water under pressure, such as a pump supplying water to a home or commercial building. The washer of this invention is simple and inexpensive enough to be useful to a homeowner to be installed over the driveway or at the entrance to the garage, for example, although its application is not limited to such use.

### BRIEF DESCRIPTION OF THE SEVERAL VIEWS OF THE DRAWINGS

In the drawing:

FIG. 1 is a somewhat diagrammatic view in front elevation showing one embodiment of this invention;

FIG. 2 is an enlarged, somewhat diagrammatic top plan view of a metering detergent dispensing apparatus shown on the left side of FIG. 1;

FIG. 3 is an enlarged, somewhat diagrammatic view in side elevation of the detergent dispensing mechanism assembly of FIGS. 1 and 2;

FIG. 4 is a reduced top plan view, again, somewhat diagrammatic, showing another embodiment of control for optionally washing and rinsing;

FIG. 5 is a somewhat diagrammatic view in front elevation, partly in section, showing washing and rinsing conduits, and

FIG. 6 is a somewhat diagrammatic view in side elevation of the mechanism shown in FIGS. 4 and 5.

### DETAILED DESCRIPTION OF THE INVENTION

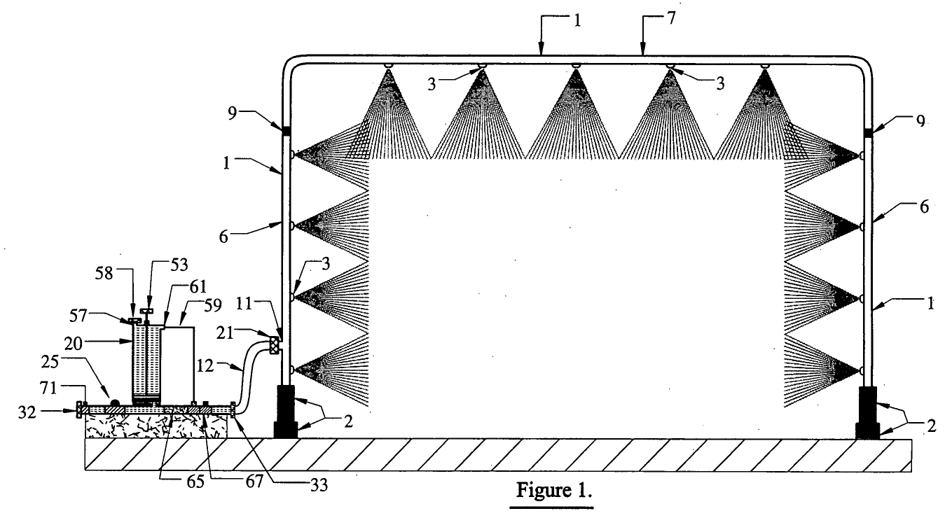

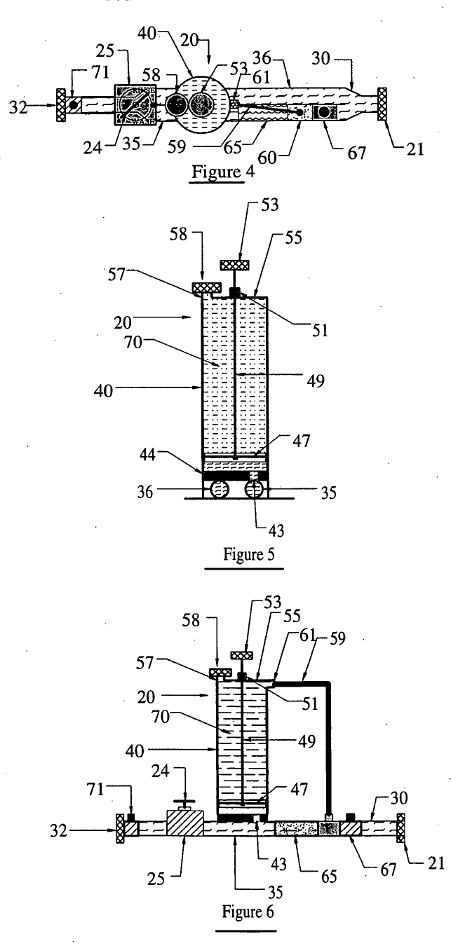

The embodiment of washer shown in FIGS. 4-6 is the bare-bones version. As will be explained, it is capable of numerous variations. Referring to FIG. 1 of the drawing for structure common to both of the illustrated and described embodiments of the vehicle wash apparatus of this invention, reference number 1 indicates a pipe frame. As is apparent from the drawing, the frame 1 is made up of vertical legs 6 and a connecting, overhead span 7, preferably connected to the legs 6 at elbows 9 in such a way that the legs can be dismounted from the span 7. The legs 6 are closed at their lower ends. Supporting feet can take the form of triangular supports as shown in Jones, et al., U.S. Pat. Nos. 4,369,801 and 4,739,779 supra, or, if the frame 1 is to be mounted over a residential driveway, for example, the feet can take the form of footings with an open topped receptacle 2 bolted to them, to take closed ends of the vertical legs 6 of pipe, to permit the pipe to be dismantled for winter storage. The pipe frame 1 has, on facing surfaces of the legs 6 and cross member 7, spray nozzles 3, spaced along the frame, communicating with the interior of the pipe. At least one of the legs 6 has a Tee 11, to which an alternative wash and rinse assembly is connected. Other elements common to the two embodiments, are designated with the same reference numerals.

The assembly is shown in FIG. 1 as being located on a base a short distance above the ground. In practice, in the embodiment shown in FIGS. 4-6, in which a handle 24 of a three way valve 25 is turned manually by the driver, it will be located at a level at which the driver of an automobile can turn the valve 25 from “off” to either “wash” or “rinse” and from “wash” to “rinse” and vice versa

Referring now to FIGS. 4-6 for one embodiment of this invention, an assembly 20, or at least the valve 25, will be located at a distance ahead of the frame, so that the hood or bonnet of the automobile to be washed will be spaced slightly ahead of the frame when the valve is turned to either the wash or rinse position, cf. Roberts U.S. Pat. No. 2,751,915, or Jones U.S. Pat. No. 4,369,801.

The assembly 20 includes a manifold 30, connected to a flexible hose 12 with a quick connect fitting 21 at one end to connect to the Tee 11, and another fitting 32, at an opposite end, to connect the manifold with a common source of water under pressure and to conduits 35 and 36.

Water to the conduit 36 is controlled by the valve 25, after which it goes unobstructedly to the Tee 11. Water to the conduit 35 is also controlled by the valve 25. After conduit 35 leaves the valve 25 the conduit passes under a detergent cylinder 40, communicating with the cylinder through an opening 43 extending through an otherwise uninterrupted bottom wall 44 of the cylinder. The cylinder 40 has in it a piston 47 and a piston rod 49 that passes through a packing gland 51 and is equipped with a handle 53 at its upper end. A filling port 57 in a top 55 of the cylinder, is capped with a removable cap 58 which, when in place, is fluid tight. A discharge port 61 completes the cylinder. The cylinder 40 contains detergent 70.

The discharge port 61 communicates with the conduit 35, through a tube 59, on the discharge side of a pressure regulator 65 in the conduit 35. The pressure regulator can be of any conventional type to ensure that the pressure exerted on the underside of the piston 47 is uniformly at a predetermined amount, for example, forty psi. The presence of the pressure regulator, will, of course, result in a reduced pressure of the water containing the detergent as it is delivered to the spray nozzles. However, this is to be desired, to conserve detergent. A check- or one-way valve 67 in the conduit 35 beyond the tube 59 ensures that water from the conduit 36 does not reach the cylinder 40.

In operation, the manifold 30 is connected to the stand 1. After the cylinder 40 has been filled with detergent and capped and a hose connection made to a water supply, a car can be driven to a point at which the driver can reach the handle 24 of the valve 25. The driver then turns the handle to either “wash” or “rinse”. If he turns the handle to “wash”, water is admitted to the conduit 35, and the pressure of the water forces the piston 47 upward, delivering detergent to the tube 59, to the conduit 35, through the check valve 67, to the manifold 30, hence to the pipe stand and shower nozzles 3. If no timer is connected to the valve, the driver backs the car to the place at which he can turn the valve 25 to the rinse position, and then moves forward under the sprays, which are discharging water at full pressure. Again, if no timer or remote control of the valve is provided, he must back the car to the place at which he can turn the valve to “off.’

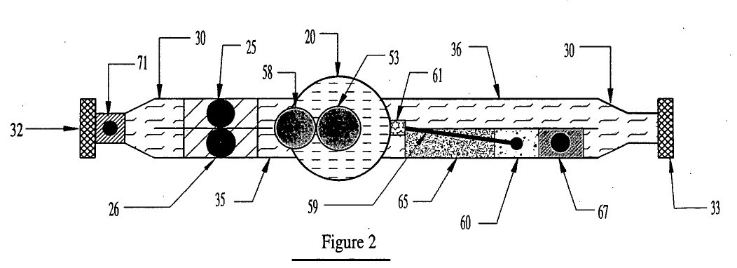

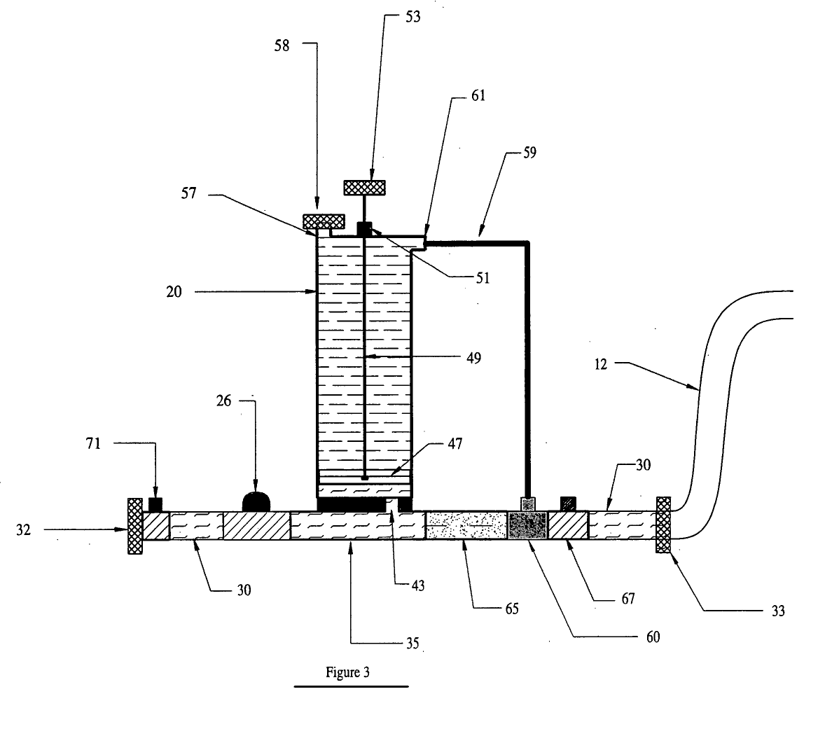

Referring to FIGS. 1-3 for another illustrative embodiment, a valve control 75 is operated electrically, either by a battery or by connection to a source of conventional power, selectively to open and close a “wash” valve 45 in conduit 35, and “rinse” valve 46, in conduit 36. Push buttons can be provided at the appropriate distance from the frame, selectively to actuate the “wash” valve 45 and the “rinse” valve 46. A switch can be provided at the far end of the car's travel, or one or more treadles or electric eyes, or a remote control of the type used with garage door openers, for example, can be used either to stop the flow, or both to start and stop the flow. In the embodiment shown a second check valve 71 is provided, to prevent back flow from the manifold 30 to the source of water.

Clearly, a timer, either electrically driven or spring operated, can be provided to operate the valves after a predetermined interval, cf. Jones '779 or Roberts '915, for example.

Because the water pressure on the underside of the piston 47 is constant, being regulated by the pressure regulator 65, the concentration of detergent in the water coming from the nozzles is constant. It has been found that four or more washes can be gotten from a cylinder ten inches tall and three inches in inside diameter. The piston preferably has a channel in its perimeter in which an O-ring is seated, the piston fitting snugly enough in the cylinder so that it stays in place when the valve is turned to “off” or “rinse”. When the cylinder is to be filled, the piston is forced down manually by means of the rod 49 and handle 53, the cap 58 is removed, the container 40 filled with detergent, and the cap replaced tightly.

Numerous other variations and modifications of the device of this invention within the scope of the appended claims will occur to those skilled in the art in view of the foregoing description. By way of example, the supports for the stand can take the form of tripods or base plates. A reach of pipe can be run at the lower, ground end of the vertical pipes of the stand, to wash the under side of the car, or, by placement of the sprays, as much of the underside as is desired, cf. Roberts, '915 supra. Two stands can be used, spaced apart in the direction of travel of the car, one for the wash and one for the rinse, cf. Jones, '779 supra. A water heater can be interposed in the water supply to the stand or stands, as can be a water softener, cf. Jones '779, to minimize spotting if the water is hard. To dry the car, a stand using air ducts instead of pipe can be supplied with air under pressure from a fixed blower or a leaf blower of the sort now in common use. The stand can be provided with wheels and be mounted on tracks, to permit the vehicle to remain stationary and the stand to be moved along the tracks manually, or, if the wheels are driven by electric motors, by the wheels themselves.

When the wheels are driven by electric motors, and the wash and rinse valves are electrically operated, the wheel motor or motors can be caused to reverse automatically and the wash valve closed and the rinse valve opened, at the end of the first, wash, pass of the frame, and the motor or motors deactivated and both wash and rinse valves closed at the end of the second, rinse, pass. The provision of tracks makes the stands more easily controlled, but if the stand is to move along a smooth path, the track can be omitted and suitable wheels employed. In either case, the wheels may be immobilized to convert the device to one in which the stand is stationary and the car, moved. The entire control unit can be, and preferably is, housed in a container equipped with a handle to permit it to be carried when not attached to the stand. When the stand is movable to wash and rinse the vehicle, either the hose from the water source or a hose from the manifold to the stand must be long enough to allow the stand to move through the length of the vehicle. The pipes constituting the vertical legs 6 and the span 7 of the stand can be made in sections, joined by couplings, to facilitate adjustment for width, and particularly height, of different vehicles, e.g., sports cars v. SUVs. These variations are merely illustrative.

1. In a free-standing car washer with sprays connected to a common source of water under pressure, the improvement comprising a device operated solely by said water under pressure from said common source for metering positively a predetermined amount of liquid detergent to said sprays.

2. The improvement of claim 1 wherein said detergent is contained in a cylinder above a piston, said cylinder communicating above said piston with a conduit to said sprays, and communicating below said piston with water under a fixed, predetermined pressure from said common source.

3. The improvement of claim 2 wherein a conduit for said water is operatively connected to said cylinder below said piston, and, through a restriction, to said sprays, whereby a predetermined part of the pressure of said water is directed to the underside of said piston, forcing said piston upward to dispense said detergent from said cylinder at a fixed, predetermined rate.

4. The improvement of claim 2 wherein a valve, interposed between said common source and said cylinder, is moveable between “off”, and “wash”and “rinse”positions to communicate with either a first conduit that leads unobstructedly to said sprays or with a second conduit that communicates with said detergent cylinder, said second conduit having in it a pressure regulator on the downstream side of the detergent cylinder and a one-way valve on the downstream side of the pressure regulator to prevent water from the first conduit from reaching the detergent cylinder,.

5. The improvement of claim 4 wherein the said sprays are connected to and communicate with pipe forming a stand, and said first and second conduits are in a common manifold connected to and communicating with said pipe.
